(19) United States
(12) Patent Application Publication
(10) Pub. No.: US 2016/0170489 A1
(43) Pub. Date: Jun. 16, 2016

(54) ELECTRONIC DEVICE AND DISPLAY METHOD THEREOF

(71) Applicant: Samsung Electronics Co., Ltd., Gyeonggi-do (KR)

(72) Inventor: Da Woon JUNG, lncheon (KR)

(73) Assignee: Samsung Electronics Co., Ltd.

(21) Appl. No.: 14/965,513

(22) Filed: Dec. 10, 2015

(30) Foreign Application Priority Data
Dec. 12, 2014 (KR) 10-2014-0179716

(51) Int. Cl. G06F 3/01

(52) U.S. Cl. CPC G06F 3/013; G06F 3/017

(57) ABSTRACT

An electronic device is provided which includes a display configured to display content on a part of a display area, a sensor module configured to sense locations of both eyes of a user, and a control module configured to change a content display area of the display based on the location of both eyes of the user.

### PRIORITY

This application claims priority under 35 U.S.C. §119(a) to a Korean Patent Application filed on Dec. 12, 2014 in the Korean Intellectual Property Office and assigned Serial No. 10-2014-0179716, the entire disclosure of which is incorporated herein by reference.

### BACKGROUND

1. Field of the Disclosure

The present disclosure generally relates to a display control method and an electronic device.

2. Description of the Related Art

With the rapid development and advancement of electronic technologies, various types of electronic devices have been developed and brought to market. In particular, portable electronic devices, such as smart phones, notebook personal computers (PC), and tablet PCs are prevalent in the marketplace.

Even though displays used in electronic devices are different from each other in physical size and aspect ratio, the shape of displays has been primarily rectangular.

The display of a portable electronic device, such as a smart phone, a wearable device, a tablet PC, and the like, may be viewed from various angles based on how the portable electronic device is placed relative to the user. When a rectangular display is viewed, the image which is displayed may be fixed to a vertical orientation or may be rotated by 90°, 180°, and 270° only based on how the portable electronic device is placed. Accordingly, a device user may look at the display from a different angle relative to the orientation of the image on the display.

### SUMMARY

Aspects of the present disclosure address at least the above-mentioned problems and/or disadvantages and provide at least the advantages described below. Accordingly, an aspect of the present disclosure is to provide an electronic device and a display method thereof which is capable of minimizing user inconvenience and increasing user satisfaction by displaying an image at various angles relative to the viewing angle of the user.

In accordance with an aspect of the present disclosure, an electronic device includes a display for displaying content on a part of a display area, a sensor module for sensing locations of both eyes of a user, and a control module for changing the content display area of the display based on the location of both eyes of the user.

In accordance with an aspect of the present disclosure, a display method of the electronic device includes displaying content on a part of a display area, sensing locations of both eyes of a user, and changing the content display area of a display based on the location of both eyes of the user.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram schematically illustrating a configuration of an electronic device according to an embodiment of the present disclosure;

FIG. 2 is a diagram schematically illustrating a display according to various embodiments of the present disclosure;

FIGS. 3A to 3D are diagrams schematically illustrating a display according to various embodiments of the present disclosure;

FIGS. 4A to 4C are diagrams schematically illustrating a display according to various embodiments of the present disclosure;

FIGS. 5A to 5D are diagrams schematically illustrating a display according to various embodiments of the present disclosure;

FIGS. 6A to 6C are diagrams schematically illustrating a display according to various embodiments of the present disclosure;

FIGS. 7A to 7F are diagrams schematically illustrating an example in which a content display area is changed according to the sensed value of a gaze sensor;

FIGS. 8A and 8B are diagrams schematically illustrating an example in which a content display area is changed according to the sensed value of a gravity sensor;

FIG. 9 is a diagram schematically illustrating a display according to various embodiments of the present disclosure;

FIGS. 10A and 10B are diagrams schematically illustrating an electronic device containing an input button;

FIG. 11 is a flowchart schematically illustrating a display method of an electronic device according to various embodiments of the present disclosure; and

FIG. 12 is a block diagram illustrating an electronic device according to various embodiments of the present disclosure.

Throughout the drawings, it should be noted that like reference numbers are used to depict the same or similar elements, features, and structures.

### DETAILED DESCRIPTION

Various embodiments of the present disclosure may be described with reference to accompanying drawings. Accordingly, those of ordinary skill in the art will recognize that modifications, changes, and/or alternatives to the various embodiments described herein can be variously made without departing from the scope and spirit of the present disclosure. With regard to description of drawings, similar components may be marked by similar reference numerals.

As herein, the expressions “have”, “may have”, “include” and “comprise”, or “includes”, “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein includes any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

Terms, such as “first”, “second”, and the like used herein may refer to various elements of various embodiments of the present disclosure, but do not limit the elements. For example, such terms do not limit the order and/or priority of the elements. Furthermore, such terms may be used to distinguish one element from another element. For example, “a first user device” and “a second user device” indicate different user devices. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it can be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to perform A, B, and C” may mean a dedicated processor (e.g., an embedded processor) for performing a corresponding operation or a generic-purpose processor (e.g., a central processing unit (CPU) or an application processor) which may perform corresponding operations by executing one or more software programs which are stored in a memory device.

Terms used in this specification are used to describe certain embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are defined in the specification, they are not to be interpreted to exclude embodiments of the present disclosure.

An electronic device according to various embodiments of the present disclosure include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, wearable devices (e.g., head-mounted-devices (HMDs), such as electronic glasses), an electronic apparel, electronic bracelets, electronic necklaces, electronic accessories, electronic tattoos, smart mirrors, smart bands, smart watches, and the like.

According to various embodiments of the present disclosure, the electronic devices may be smart home appliances. The smart home appliances includes at least one of for example, televisions (TVs), digital versatile disc (DVD) players, audio players, refrigerators, air conditioners, cleaners, ovens, microwave ovens, washing machines, air cleaners, set-top boxes, TV boxes (e.g., Samsung HomeSync™, Apple TV™, or Google TV™), game consoles (e.g., Xbox™ and PlayStation™), electronic dictionaries, electronic keys, camcorders, electronic picture frames, and the like.

According to various embodiments of the present disclosure, the electronic devices include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices, navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller machines (ATMs), points of sales (POS) devices, or Internet of Things (IoT) (e.g., light bulbs, various sensors, electric or gas meters, sprinkler devices, fire alarms, thermostats, street lamps, toasters, exercise equipment, hot water tanks, heaters, boilers, and the like).

According to an embodiment of the present disclosure, the electronic devices includes at least one of furniture or buildings/structures, electronic boards, electronic signature receiving devices, projectors, or various measuring instruments (e.g., water meters, electricity meters, gas meters, or wave meters, and the like). The electronic devices according to an embodiment of the present disclosure may be one or more combinations of the above-mentioned devices. According to a particular embodiment of the present disclosure, an electronic device may be a flexible electronic. Electronic devices according to various embodiments of the present disclosure are not limited to the above-mentioned devices, and include new electronic devices according to the development of new technologies.

Hereinafter, electronic devices according to an embodiment of the present disclosure will be described with reference to the accompanying drawings. The term “user” used herein refers to a person who uses an electronic device or refers to a device (e.g., an artificial intelligence electronic device) that uses an electronic device.

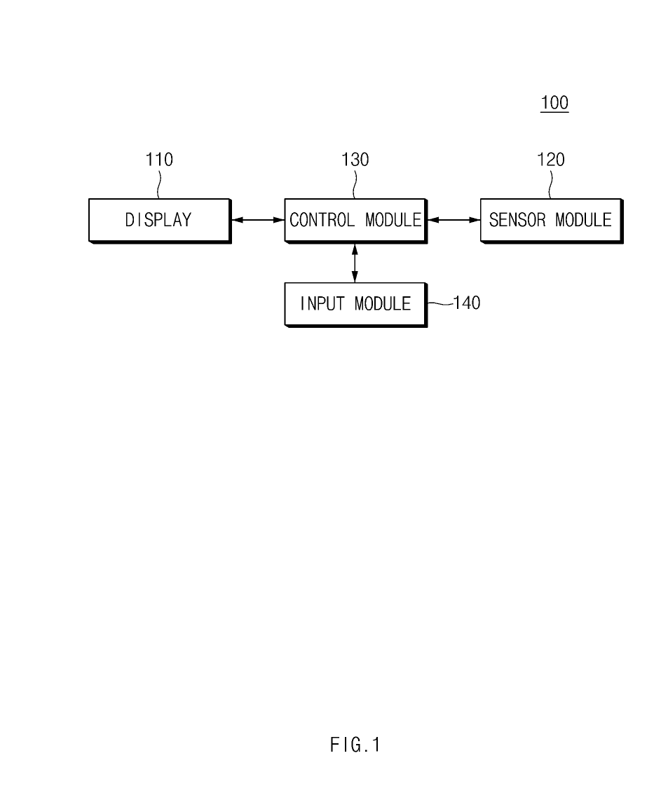

FIG. 1 is a block diagram schematically illustrating a configuration of an electronic device according to an embodiment of the present disclosure.

Referring to FIG. 1, an electronic device 100 includes a display 110, a sensor module 120, a control module 130, and an input module 140. The electronic device 100 may be implemented with various portable electronic devices. For example, the electronic device 100 may be implemented with portable electronic devices such as a smart phone, a wearable device (e.g., a smart watch, a smart band, and the like), a tablet PC, a notebook PC, a personal data assistant (PDA), and the like.

The display 110 displays content or various user interfaces (UIs) provided by various electronic devices. The display 110 includes a content display area which displays the content and a supplementary function display area which displays a function key, a user interface (UI) related to an application running on the electronic device 100, and the like.

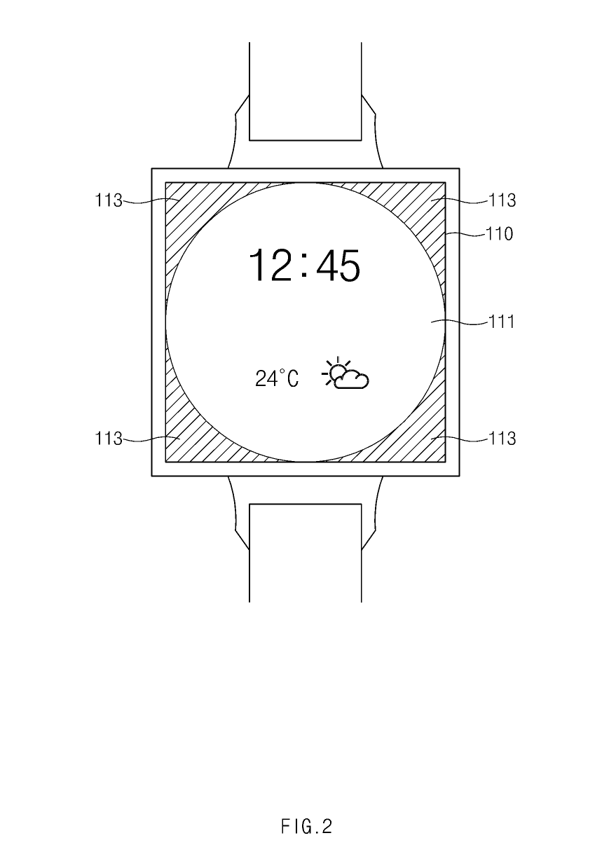

The structure of the display 110 will be described in detail with reference to FIG. 2.

FIG. 2 is a diagram illustrating a display according to various embodiments of the present disclosure.

Referring to FIG. 2, the display 110 includes the content display area 111 and the supplementary function display area 113. According to an embodiment of the present disclosure, the supplementary function display area 113 may be a remaining area of the display area other than the content display area 111. According to an embodiment of the present disclosure, the content display area 111 may be located at a center portion of the display 110, and the supplementary function display area 113 may be located so as to surround the content display area 111.

Referring to FIG. 2, the shape of the display 110 may be square or rectangular. Alternatively, the shape of the display 110 may be circular, oval, or a polygon (e.g., pentagon, octagon, and the like). Referring to FIG. 2, the content display area 111 may be circular in shape. Alternatively, the shape of the content display area 111 may be oval or a polygon (e.g., square, rectangle, octagon, and the like).

The supplementary function display area 113 may be divided into a plurality of areas based on the shape, size, or angle of the content display area 111. For example, referring to FIG. 2, the display 110 includes four supplementary function display areas 113.

The sensor module 120 senses the location of both eyes of a user of the electronic device. According to an embodiment of the present disclosure, the sensor module 120 includes a variety of sensors that sense the location of both eyes of the user. For example, the sensor module 120 includes a gaze sensor. According to an embodiment of the present disclosure, the sensor module 120 includes a camera. According to an embodiment of the present disclosure, the sensor module 120 captures an image containing both eyes of the user with the camera and then the sensor module 120 computes the location of both eyes.

According to an embodiment of the present disclosure, the sensor module 120 includes a gravity sensor (or an inertial or acceleration sensor). According to an embodiment of the present disclosure, the gravity sensor senses the direction of gravity. According to an embodiment of the present disclosure, the gravity sensor obtains a vector value of the direction of gravity.

According to an embodiment of the present disclosure, the sensor module 120 includes a gyro sensor. The gyro sensor senses angular velocity and angular acceleration based on a movement of the electronic device 100.

The control module 130 controls the overall operation of the electronic device 100. The control module 130 controls the display 110, the sensor module 120, and the input module 140 respectively and changes the content display area 111 of the display 110 according to various embodiments of the present disclosure.

The control module 130 changes the content display area 111 of the display 110 based on data obtained from the sensor module 120. According to an embodiment of the present disclosure, the control module 130 changes the shape, the size, or the angle of the content display area 111. For example, the control module 130 changes the size or the angle of the content display area 111 while the shape of the content display area 111 remains fixed. As another example, the control module 130 changes the size of the content display area 111 so as to have a maximum size at a specific angle without changing the shape of the content display area 111. As another example, the control module 130 changes the shape of the content display area 111 by rotating the content display area 111 relative to the center point of the display.

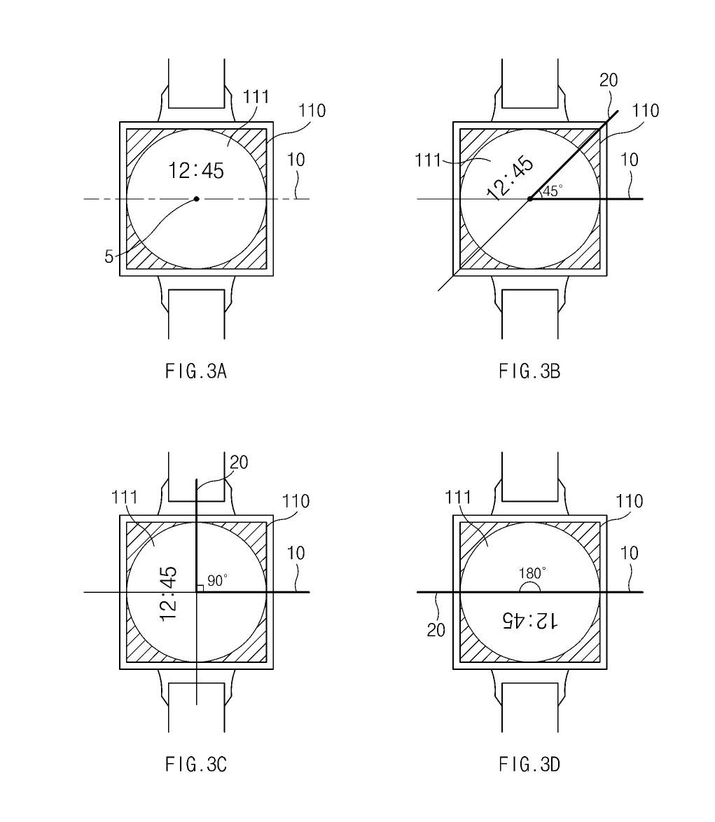

An operation in which the content display area 111 of the display 110 is changed will be described with reference to FIGS. 3 to 5.

FIGS. 3A to 3D are diagrams illustrating a display according to various embodiments of the present disclosure.

FIGS. 3A to 3D illustrate examples in which the content display area 111 is changed in the case where the display 110 is square in shape and the content display area 111 is circular in shape. FIG. 3A shows the display 110 corresponding to a reference state in which the content display area 111 is not changed. Referring to FIG. 3A, the content may be displayed on the content display area 111 of the display 110. In the reference state, a straight line which passes through the center point 5 of the display 110 is parallel with the content displayed on the content display area 111 may be designated as a reference line 10. FIGS. 3B to 3D show the display 110 corresponding to a state in which the content display area 111 is rotated. Referring to FIG. 3B, the angle is rotated by 45° from the reference line 10 compared with a horizontal line 20 in parallel with the content displayed on the content display area 111. Referring to FIG. 3C the angle is rotated by 90° from the reference line 10 compared with the horizontal line 20 in parallel with the content displayed on the content display area 111. Referring to FIG. 3D, the angle is rotated by 180° from the reference line 10 compared with the horizontal line 20 in parallel with the content displayed on the content display area 111. The angle of the content display area 111 may be changed freely within a range from 0° to 360° as well as 45°, 90°, and 180°.

Referring to FIGS. 3A to 3D, the angle of the content display area 111 may be independently rotated without changing the shape and size of the content display area 111. The content display area 111 may be rotated relative to the center point of the display.

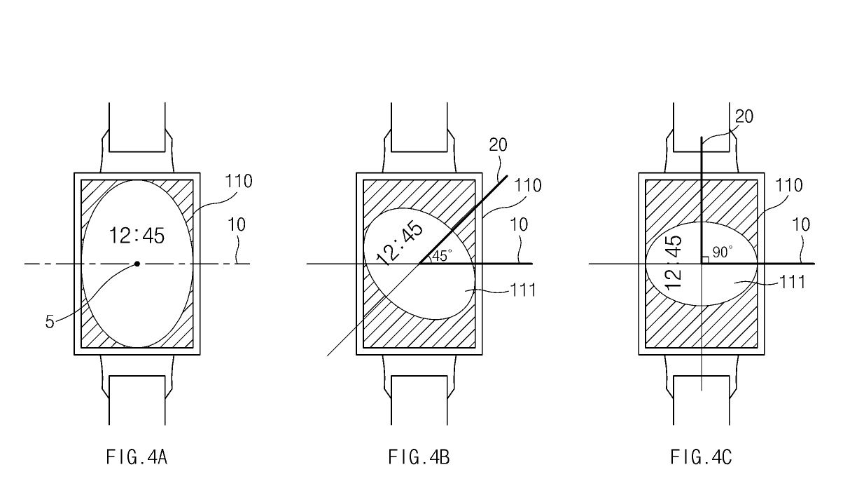

FIGS. 4A to 4C are diagrams illustrating a display according to various embodiments of the present disclosure.

FIGS. 4A to 4C illustrate examples in which the content display area 111 is changed in the case where the display 110 is rectangular in shape and the content display area 111 is oval in shape. FIG. 4A shows the display 110 corresponding to the reference state in which the content display area 111 is not changed. Referring to FIG. 4A, the content may be displayed on the content display area 111 of the display 110. In the reference state, a straight line which passes through the center point 5 of the display 110 and is parallel with the content displayed on the content display area 111 may be designated as the reference line 10. FIG. 4B and FIG. 4C show the display 110 corresponding to a state in which the content display area 111 is changed. Referring to FIG. 4B, the angle is rotated by 45° from the reference line 10 compared with the horizontal line 20 in parallel with the content displayed on the content display area 111. The size of the content display area 111 may be changed to have a maximum size without changing the shape of the content display area 111. Referring to FIG. 4C, the angle is changed by 90°, from the reference line 10 compared with the horizontal line 20 in parallel with the content displayed on the content display area 111. The size of the content display area 111 may be changed so as to have a maximum size without changing the shape of the content display area 111.

Referring to FIGS. 4A to 4C, the content display area 111 may have the maximum size at 0° or 180° and may have the minimum size at 90° or 270°. The angle of the content display area 111 may be changed freely within the range from 0° to 360° as well as 45° and 90°.

Referring to FIGS. 4A to 4C, the size or the angle of the content display area 111 may be changed while the shape of the content display area 111 is unchanged. The content display area 111 may be rotated relative to the center point of the display.

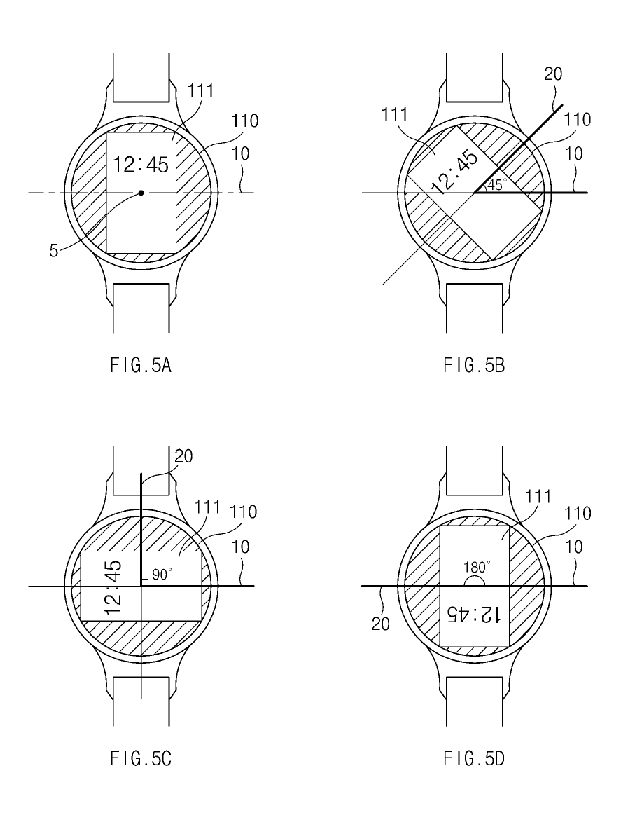

FIGS. 5A to 5D are diagrams illustrating a display according to various embodiments of the present disclosure.

FIGS. 5A to 5D illustrate examples in which the content display area 111 is changed in the case where the display 110 is circular in shape and the content display area 111 is rectangular in shape. FIG. 5A shows the display 110 corresponding to a reference state in which the content display area 111 is not changed. Referring to FIG. 5A, the content is displayed on the content display area 111 of the display 110. In the reference state, a straight line which passes through the center point 5 of the display 110 and is parallel with the content displayed on the content display area 111 may be set as the reference line 10. FIGS. 5B to 5D show the display 110 corresponding to a state in which the content display area 111 is rotated. Referring to FIG. 5B, the angle is rotated by 45° from the reference line 10 compared with the horizontal line 20 in parallel with the content displayed on the content display area 111. Referring to FIG. 5C, the angle is rotated by 90° from the reference line 10 compared with the horizontal line 20 in parallel with the content displayed on the content display area 111. Referring to FIG. 5D, the angle is rotated by 180° from the reference line 10 compared with the horizontal line 20 in parallel with the content displayed on the content display area 111. The angle of the content display area 111 may be changed freely within the range from 0° to 360° as well as 45°, 90°, and 180°.

Referring to FIGS. 5A to 5D, the angle of the content display area 111 may be independently rotated without changing the shape and size of the content display area 111. The content display area 111 may be rotated relative to the center point of the display.

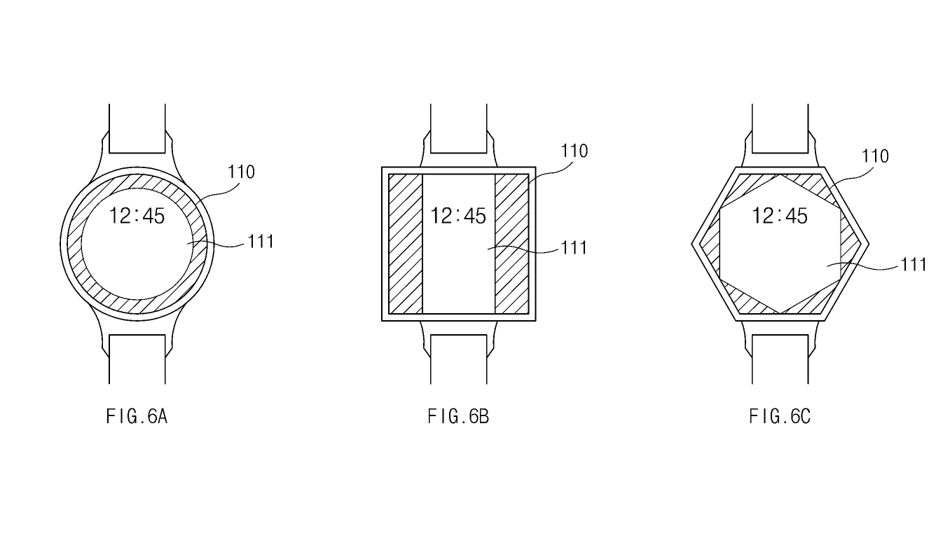

FIGS. 6A to 6C are diagrams illustrating a display according to various embodiments of the present disclosure.

FIGS. 6A to 6C illustrate various examples of the display 110 and the content display area 111.

FIG. 6A shows an example in which both the display 110 and the content display area 111 are circular in shape. Referring to FIG. 6A, the content display area 111 may have the same center point as the display area of the display 110 and may have the shape of a circle the size of which is smaller than that of the display area. According to various embodiments of the present disclosure, the content display area 111 may have the shape of a circle the size of which is less than or equal to that of the display 110.

FIG. 6B shows an example in which the display 110 is square in shape and the content display area 111 is rectangular in shape. FIG. 6C shows an example in which both the display 110 and the content display area 111 are hexagonal in shape and their respective vertices are not located at the same position.

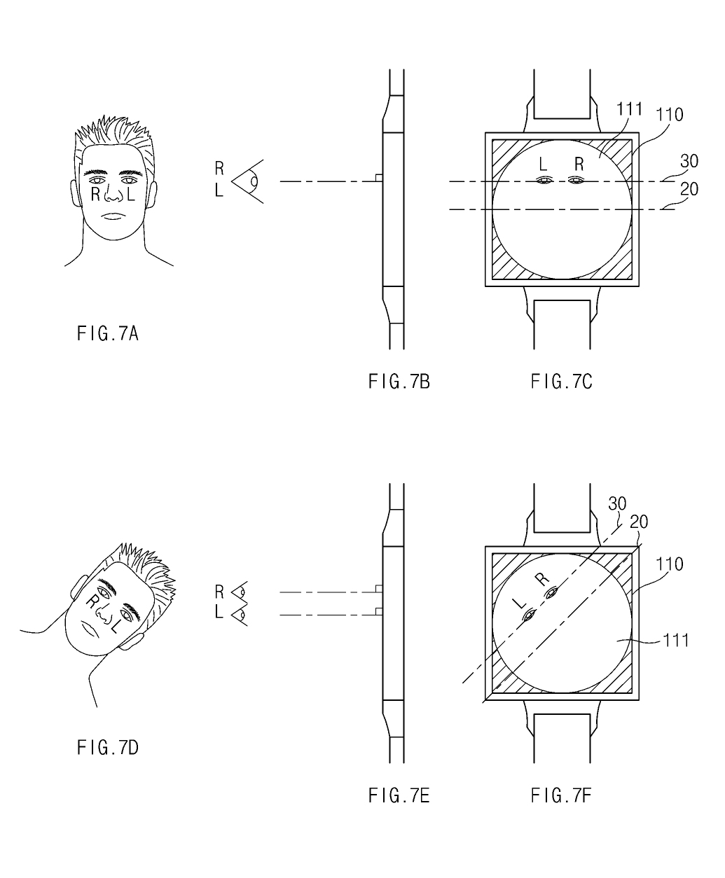

The control module 130 may change the content display area 111 of the display 110 based on the sensing value of the gaze sensor. According to an embodiment of the present disclosure, the control module 130 may change the angle of the content display area 111 such that the horizontal line in the content display area 111 is in parallel with a perpendicularly projected line of a straight line passing through both eyes of the user on a display surface. The display surface may refer to a plane of the display 110 on which the content is displayed. This will be described with reference to FIGS. 7A to 7F.

FIGS. 7A to 7F are diagrams illustrating examples in which the content display area is changed according to the sensing value of the gaze sensor. As an example of various embodiments of the present disclosure, FIGS. 7A to 7C show an example in which the user looks at the display 110 at an angle where the perpendicular direction of both eyes of the user corresponds to the perpendicular direction of the electronic device 100. FIGS. 7D to 7F show an example in which the user looks at the display 110 with the user's head slanted to the left, compared with FIGS. 7A to 7C.

FIG. 7A shows the face of the user viewed from the electronic device 100. FIG. 7B is a side view of the display 110 with the user looking at the display 110. FIG. 7C illustrates the content display area 111 changed according to the angle of the user's gaze. If the location of both eyes of the user are sensed with the gaze sensor, the straight line passing through both eyes of the user may be perpendicularly projected on the display surface as shown in FIG. 7B. Referring to FIG. 7C, the straight line passing through both eyes of the user may be perpendicularly projected on the display surface, thereby obtaining one straight line 30 on the display surface. The content display area 111 may be rotated such that the horizontal line 20 of the content display area 111 is parallel with the straight line 30.

FIG. 7D shows the face of the user viewed from the electronic device 100. FIG. 7E is a side view of the display 110 with the user looking at the display 110. FIG. 7F illustrates the content display area 111 rotated according to the user's gaze. If the location of both eyes of the user are sensed by the gaze sensor, the straight line passing through both eyes of the user may be perpendicularly projected on the display surface as shown in FIG. 7E. Referring to FIG. 7F, the straight line passing through both eyes of the user may be perpendicularly projected on the display surface, thereby obtaining one straight line 30 on the display surface. The content display area 111 may be rotated such that the horizontal line 20 of the content display area 111 is parallel with the straight line 30.

Referring to FIGS. 7A to 7F, the angle of a straight line projected on the display surface may be rotated according to the location of the user looking at the electronic device 100, thereby changing the angle of the content display area 111.

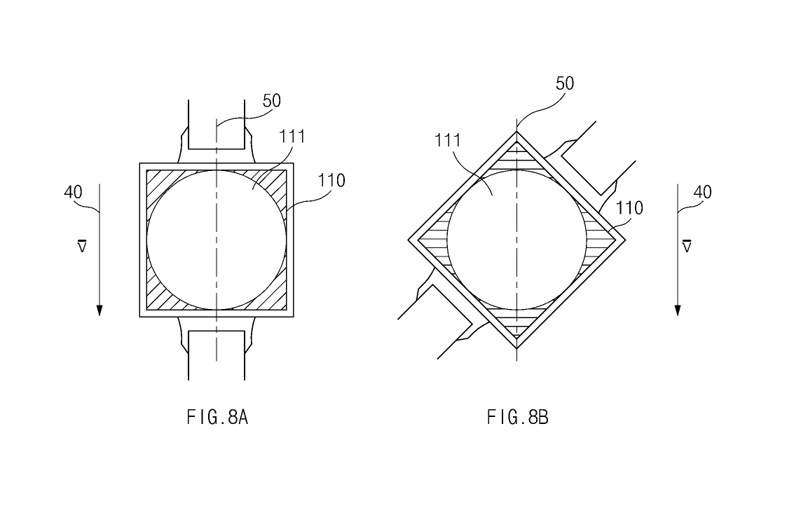

According to an embodiment of the present disclosure, the control module 130 changes the content display area 111 of the display 110 based on the direction of gravity obtained from the gravity sensor. According to an embodiment of the present disclosure, the control module 130 changes the content display area 111 such that a perpendicular line in the content display area is in parallel with a perpendicularly projected vector of the direction of gravity obtained from the gravity sensor on the display surface. This will be described with reference to FIGS. 8A and 8B.

FIGS. 8A and 8B are diagrams illustrating an example in which the content display area is changed according to the sensed value of the gravity sensor.

FIG. 8A is a diagram illustrating the content display area 111 in the case where the electronic device 100 is placed perpendicular to a level ground, and FIG. 8B is a diagram illustrating the content display area 111 in the case where the electronic device 100 is inclined to the right with the electronic device 100 being placed perpendicular to level ground.

If the direction of gravity is obtained from the gravity sensor, the vector representing the direction of gravity may be perpendicularly projected on the display surface. Accordingly, the vector 40 may be obtained with respect to the display surface. The content display area 111 may be rotated such that the vertical line 50 in the content display area 111 is parallel to the vector 40.

Accordingly, the direction indicated by the vector 40 projected on the display surface may be a downward direction of the content displayed on the content display area 111 regardless of the direction in which the electronic device is placed.

According to an embodiment of the present disclosure, the control module 130 changes the content display area 111 of the display 110 based on the value of the angular velocity obtained from the gyro sensor. For example, the control module 130 calculates a variation in angular rotation (or an angle variation) of a plane containing the display surface based on the value of the angular velocity and may rotate the content display area 111 of the display 110 so as to correspond to the variation in rotation of the plane containing the display surface.

According to an embodiment of the present disclosure, the control module 130 performs control to display a function key on the supplementary function display area 113. According to an embodiment of the present disclosure, the function key includes at least one of a home key, a back key, a volume control key, a screen brightness control key, or a menu key.

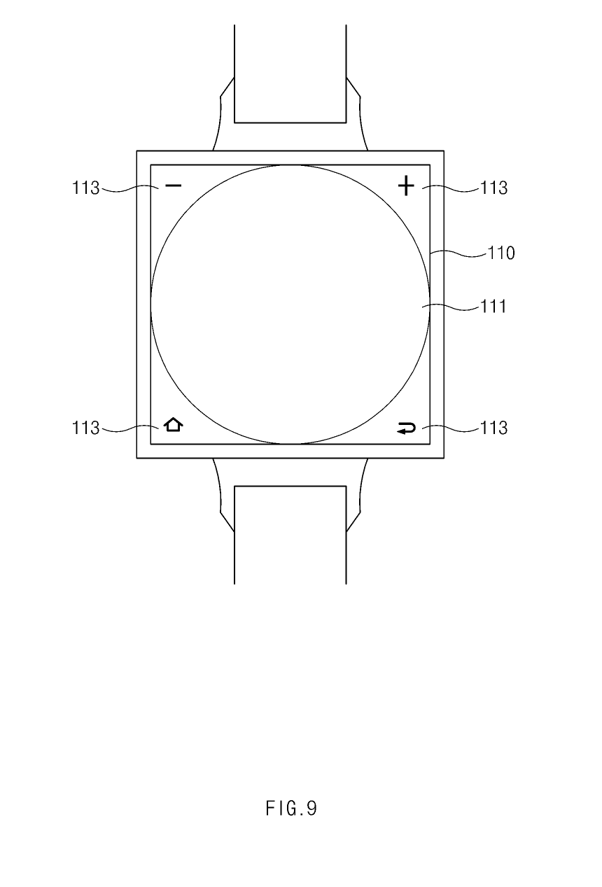

FIG. 9 is a diagram illustrating a display according to various embodiments of the present disclosure.

Referring to FIG. 9, the function key may be displayed on the supplementary function display area 113 of the display 110. According to an embodiment of the present disclosure, in the case where the supplementary function display area 113 is divided into a plurality of areas, the divided supplementary function display areas 113 display different function keys. As shown in FIG. 9, the home key may be displayed on the bottom left, the back key on the bottom right, the volume-down key on the top left, and the volume-up key on the top right.

According to an embodiment of the present disclosure, the control module 130 controls the kinds of function keys, the number of function keys, or an arrangement of function keys according to the shape or size of the supplementary function display area 113. For example, the control module 130 controls one function key displayed on a narrow area and a plurality of the function keys displayed on a wide area.

The input module 140 includes a touch screen (or a touch pad) operated by a touch input or an input button operated by the user pressing the input button. According to an embodiment of the present disclosure, the input button includes at least one hardware key.

According to an embodiment of the present disclosure, if the content display area is changed, the control module 130 changes the function of the input button based on a different angle of the content display area.

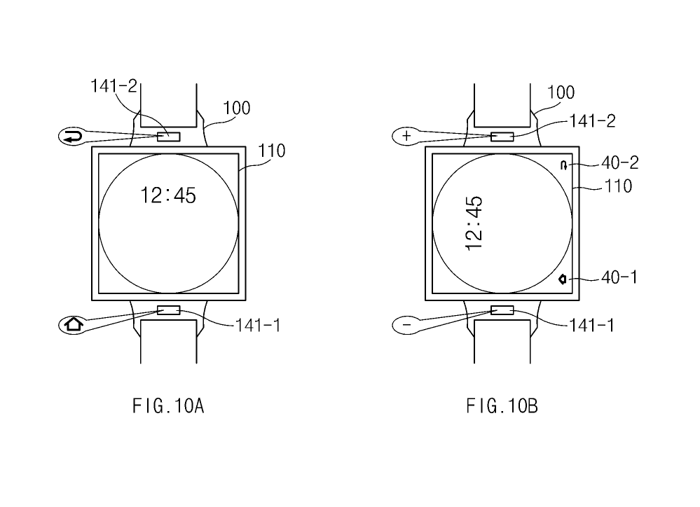

FIGS. 10A and 10B are diagrams illustrating an electronic device containing an input button.

FIG. 10A shows the display 110 corresponding to a reference state in which the content display area is not changed. Referring to FIG. 10A, the electronic device 100 includes a plurality of input buttons 141-1 and 141-2. The plurality of input buttons 141-1 and 141-2 may have different functions from each other. For example, a first input button 141-1 located on the bottom of the display 110 may function as a home key and a second input button 141-2 located on the top of the display 110 may function as a cancel key. The location of the plurality of input buttons 141-1 and 141-2 are not limited to the top and bottom of the display 110. For example, the plurality of input buttons 141-1 and 141-2 may be located on the sides including the left and right sides or on an accessory, for example a watch strip, connected to the electronic device 100. FIG. 10B illustrates the display 110 corresponding to an angle of the content display area rotated by 90° compared with FIG. 10A. Referring to FIG. 10B, the functions of the plurality of input buttons 141-1 and 141-2 may be changed. According to an embodiment of the present disclosure, the functions of the plurality of input buttons may be changed according to the different angle of the content display area. For example, if the angle of the content display area is rotated by 90°, the first input button 141-1 may have a function of the volume down key, and the second input button 141-2 may have a function of the volume-up key. For another example, if the angle of the content display area is rotated by 180°, the first input button 141-1 may function as a cancel key, and the second input button 141-2 may function as a home key.

According to an embodiment of the present disclosure, if the function of the input button is changed, the control module 130 changes a function key on the display to have the previous function of the input button before the change. According to an embodiment of the present disclosure, the function key having the previous function of the input button before the change may be displayed on the supplementary function display area 113. For example, referring to FIG. 10B, if the functions of the plurality of input buttons 141-1 and 141-2 are changed from the home key and the cancel key to the volume-down key and the volume-up key, respectively, the home key 40-1 and the cancel key 40-2 may be displayed on the display 110.

According to an embodiment of the present disclosure, if a specific time period elapses after the function key having the previous function of the input button before a change is displayed, the control module 130 deletes the function key from the display 110. For example, referring to FIG. 10B, the home key 40-1 and the cancel key 40-2 displayed on the display 110 may be displayed during the specific time and then may disappear from the display 110 or may be changed to different function keys after the specific time elapses.

According to an embodiment of the present disclosure, the control module 130 displays a UI related to an application running on the electronic device 100 on the supplementary function display area 113. According to an embodiment of the present disclosure, the control module 130 displays various UIs provided by the application running on the supplementary function display area 113.

According to embodiments of the present disclosure, an electronic device includes a display for displaying content, a sensor module for sensing the location of both eyes of a user, and a control module for changing a content display area of the display based on the location of both eyes of the user.

According to embodiments of the present disclosure, the control module changes at least one of the shape, size, or angle of the content display area.

According to embodiments of the present disclosure, the control module changes the shape of the content display area by rotating the content display area relative to the center point of the display.

According to various embodiments of the present disclosure, the control module changes the angle of the content display area such that a horizontal line in the content display area is parallel with a perpendicularly projected line of a straight line passing through both eyes of the user on a display surface.

According to various embodiments of the present disclosure, the control module changes the size of the content display area so as to maximize the size of the content display area without changing the shape of the content display area.

According to embodiments of the present disclosure, the electronic device includes a gravity sensor for sensing the direction of gravity, and the control module changes the content display area of the display based on the direction of gravity.

According to embodiments of the present disclosure, the control module changes the content display area such that a perpendicular line in the content display area is parallel with a perpendicularly projected vector of a vector indicating the direction of gravity on the display surface.

According to embodiments of the present disclosure, the control module displays a function key on an area of the display area other than the content display area.

According to embodiments of the present disclosure, the function key includes at least one of a home key, a back key, a volume control key, a screen brightness control key, or a menu key.

According to various embodiments of the present disclosure, the electronic device includes an input button having a first function, and the control module changes the function of the input button based on a different angle of the content display area in the case where the content display area is changed.

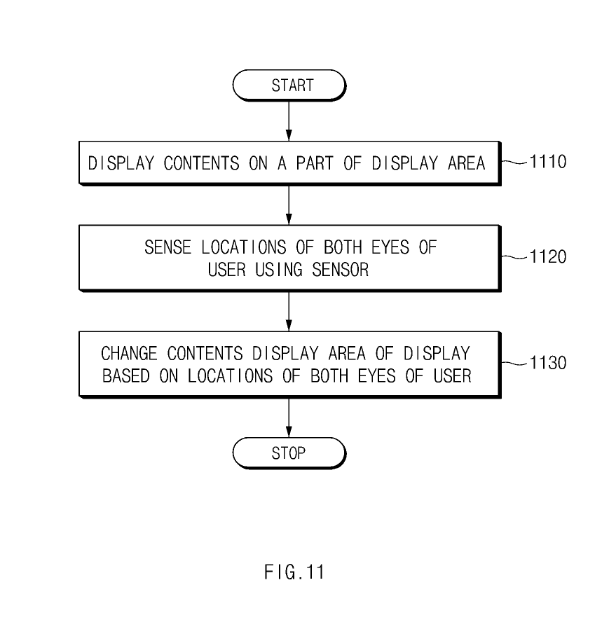

FIG. 11 is a diagram illustrating a display method of an electronic device according to embodiments of the present disclosure. A flowchart shown in FIG. 11 includes steps processed in the electronic device 100 shown in FIG. 1. Even though not described below, information about the electronic device 100 described with reference to FIGS. 1 to 10 may be applied to the flowchart illustrated in FIG. 11.

Referring to FIG. 11, in step 1110, the electronic device 100 displays the content on a part (e.g., the content display area) of the display area. In step 1120, the electronic device 100 senses the location of both eyes of the user using the sensor module 120. According to an embodiment of the present disclosure, the sensor module 120 includes a variety of sensors that sense the location of both eyes of the user. For example, the sensor module includes a gaze sensor. In step 1130, the electronic device 100 changes the content display area of the display based on the location of both eyes of the user obtained from the sensor module.

According to an embodiment of the present disclosure, the electronic device 100 changes the shape, the size, or the angle of the content display area 111. For example, the electronic device 100 changes the size or the angle of the content display area while the shape of the content display area remains fixed. As another example, the electronic device 100 changes the size of the content display area so as to have a maximum size at a specific angle without changing the shape of the content display area. As another example, the electronic device 100 changes the content display area by rotating the content display area relative to the center point of the display.

According to an embodiment of the present disclosure, the control module changes the angle of the content display area such that the horizontal line in the content display area is parallel with the perpendicularly projected line of a straight line passing through both eyes of the user on the display surface.

According to an embodiment of the present disclosure, the electronic device 100 senses the direction of gravity with the gravity sensor. According to an embodiment of the present disclosure, the electronic device 100 changes the content display area of the display based on the direction of gravity obtained from the gravity sensor. According to an embodiment of the present disclosure, the electronic device 100 changes the content display area such that the perpendicular line of the content display area is parallel with the perpendicularly projected vector of the direction of gravity obtained from the gravity sensor on the display surface.

According to an embodiment of the present disclosure, the electronic device 100 changes the content display area 111 of the display 110 based on the angular velocity obtained from the gyro sensor. For example, the electronic device 100 calculates a variation in rotation of a plane containing the display surface based on the angular velocity or angular acceleration and rotates the content display area 111 of the display 110 to correspond to the variation in rotation of the plane containing the display surface.

According to embodiments of the present disclosure, the electronic device 100 displays a function key on the area (e.g., supplementary function display area) of the display area other than the content display area. According to an embodiment of the present disclosure, the function key includes at least one of the home key, the back key, the volume control key, the screen brightness control key, or the menu key.

According to an embodiment of the present disclosure, if the content display area is changed, the electronic device 100 changes the function of the input button based on the different angle of the content display area.

According to an embodiment of the present disclosure, if the function of the input button is changed, the electronic device 100 displays the function key having the previous function of the input button before a change. According to an embodiment of the present disclosure, the function key having the previous function of the input button before the change may be displayed on the supplementary function display area 113.

According to an embodiment of the present disclosure, if a specific time elapses after the function key having the previous function of the input button before a change is displayed, the electronic device 100 deletes the function key from the display 110.

According to an embodiment of the present disclosure, the electronic device 100 displays the function key on the area (e.g., the supplementary function display area) of the display other than the content display area. According to an embodiment of the present disclosure, the control module 130 displays various UIs provided by the application running on the supplementary function display area.

According to embodiments of the present disclosure, a display method of an electronic device includes displaying content on a part of a display area, sensing the location of both eyes of a user using a gaze sensor, and changing a content display area of a display based on the sensed value of the gaze sensor.

According to embodiments of the present disclosure, a display method of an electronic device includes displaying content on a part of a display area, sensing the location of both eyes of a user using a gaze sensor, and changing a content display area of a display based on the location of both eyes of the user.

According to embodiments of the present disclosure, the changing of the content display area of the display includes changing at least one of a shape, a size, or an angle of the content display area.

According to embodiments of the present disclosure, the changing of the content display area of the display includes changing the content display area by rotating the content display area relative to the center point of the display.

According to various embodiments of the present disclosure, the changing of the content display area of the display includes changing the content display area such that a horizontal line of the content display area is parallel with a perpendicularly projected line of a straight line passing through both eyes of a user on a display surface.

According to embodiments of the present disclosure, the changing of the content display area of the display includes changing the size of the content display area so as to have a maximum size without changing the shape of the content display area.

According to embodiments of the present disclosure, the display method of the electronic device includes sensing the direction of gravity with a gravity sensor and changing the content display area of the display based on the direction of gravity.

According to embodiments of the present disclosure, the changing of the content display area of the display based on the direction of gravity includes changing an angle of the content display area such that a perpendicular line in the content display area is parallel with a perpendicularly projected vector of a vector indicating the direction of gravity on the display surface.

According to various embodiments of the present disclosure, the display method of the electronic device includes displaying a function key on an area of the display area other than the content display area.

According to various embodiments of the present disclosure, the display method of the electronic device includes changing the function of an input button based on a different angle of the content display area in the case where the content display area is changed and displaying a function key having a previous function of the input button before a change on the display.

According to various embodiments of the present disclosure, the display method of the electronic device includes deleting a function key having a first function from the display if a time period elapses after the function key having the first function is displayed.

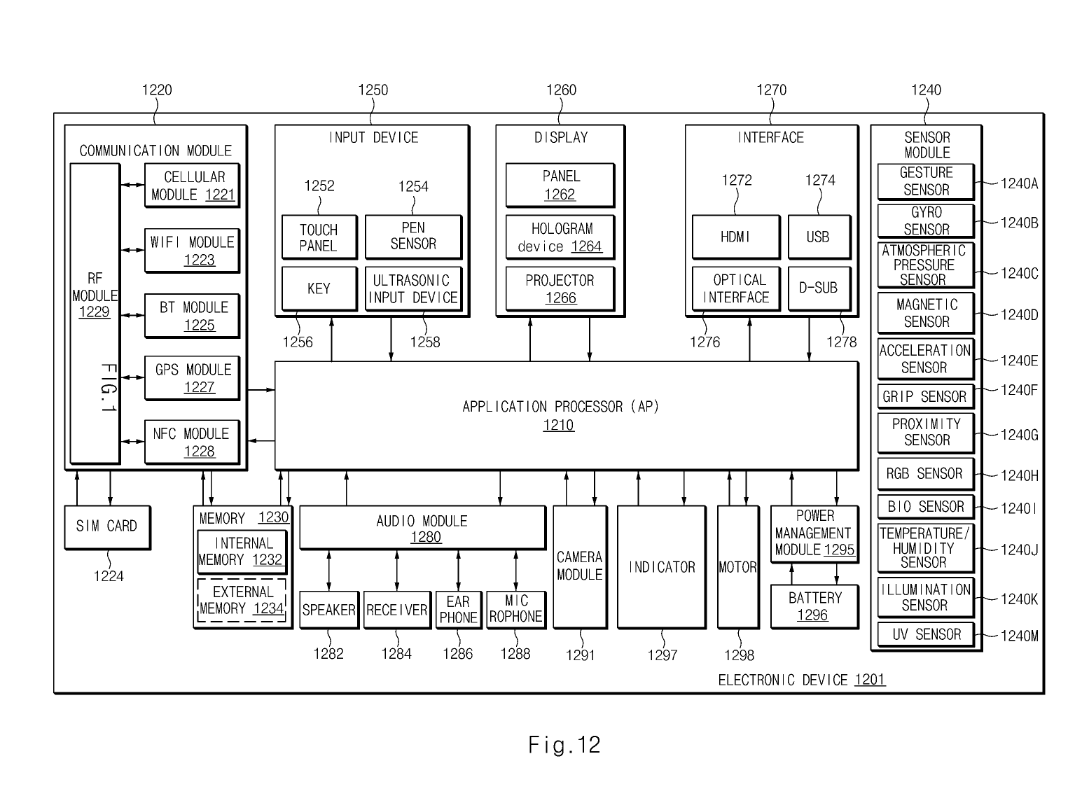

FIG. 12 is a block diagram illustrating an electronic device 1001 according to embodiments of the present disclosure.

Referring to FIG. 12, an electronic device 1201 includes, for example, all or part of an electronic device 100 illustrated in FIG. 1. The electronic device 1201 includes one or more processors (e.g., an application processor (AP), a graphics processor, and the like) 1210, a communication module 1220, a subscriber identification module 1224, a memory 1230, a sensor module 1240, an input device 1250, a display 1260 (e.g., the display 110), an interface 1270, an audio module 1280, a camera module 1291, a power management module 1295, a battery 1296, an indicator 1297, and a motor 1298.

The processor 1210 may execute the instructions of an operating system (OS) or an application program to control a plurality of hardware or software components connected to the processor 1210 and may process and compute a variety of data. The processor 1210 may be implemented as a System on Chip (SoC), for example. According to an embodiment of the present disclosure, the processor 1210 includes a graphic processing unit (GPU) and/or an image signal processor. The processor 1210 includes at least a part (e.g., a cellular module 1221) of the components illustrated in FIG. 12. The processor 1210 loads and processes instructions and/or data, which is retrieved from memory and stores a variety of data in nonvolatile memory.

The communication module 1220 includes a cellular module 1221, a wireless-fidelity (Wi-Fi) module 1223, a Bluetooth (BT) module 1225, a global positioning system (GPS) module 1227, a near field communication (NFC) module 1228, and a radio frequency (RF) module 1229.

The cellular module 1221 provides voice communications, data communications, multimedia communications, a messaging service, an Internet access service and the like through a cellular communications network. According to an embodiment of the present disclosure, the cellular module 1221 performs authorization and authentication of an electronic device 1201 within a communications network using a subscriber identification module 1224 (e.g., a SIM card or software SIM). According to an embodiment of the present disclosure, the cellular module 1221 performs at least a portion of functions that the processor 1210 provides. According to an embodiment of the present disclosure, the cellular module 1221 includes a communication processor (CP).

Each of the Wi-Fi module 1223, the BT module 1225, the GPS module 1227, and the NFC module 1228 includes a processor for processing data exchanged through a corresponding module. According to an embodiment of the present disclosure, at least a portion (e.g., two or more components) of the cellular module 1221, the Wi-Fi module 1223, the BT module 1225, the GPS module 1227, the RF module 1229, and the NFC module 1228 may be included within one Integrated Circuit (IC), a multichip module or an IC package.

The RF module 1229 transmits and receives a communication signal (e.g., an RF signal). The RF module 1229 includes a transceiver, a power amplifier module (PAM), a frequency filter, a low noise amplifier (LNA), an antenna, and the like. According to various embodiments of the present disclosure, at least one of the cellular module 1221, the Wi-Fi module 1223, the BT module 1225, the GPS module 1227, or the NFC module 1228 may transmit and receive an RF signal through a separate RF module.

The subscriber identification module 1224 includes unique subscriber identify information (e.g., integrated circuit card identifier (ICCID)) or subscriber information (e.g., integrated mobile subscriber identity (IMSI) and international mobile electronic identity (IMEI)).

The memory 1230 includes an internal memory 1232 and an external memory 1234. For example, the internal memory 1232 includes at least one of a volatile memory (e.g., a dynamic random access memory (DRAM), a static RAM (SRAM), or a synchronous DRAM (SDRAM)), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a NAND flash memory, or a NOR flash memory), a hard drive, or a solid state drive (SSD).

The external memory 1234 includes a flash drive, compact flash (CF), secure digital (SD), micro secure digital (Micro-SD), mini secure digital (Mini-SD), extreme digital (xD), multimedia card (MMC), a memory stick, and the like. The external memory 1234 may be functionally and/or physically connected to the electronic device 1001 through various interfaces.

The sensor module 1240 (e.g., the sensor module 120) measures a physical quantity or detects an operational state of the electronic device 1201. The sensor module 1240 converts the measured or detected information into an electric signal. The sensor module 1240 includes at least one of a gesture sensor 1240A, a gyro sensor 1240B, a pressure sensor 1240C, a magnetic sensor 1240D, an acceleration sensor 1240E, a grip sensor 1240F, a proximity sensor 1240G, a color sensor 1240H (e.g., red, green, blue (RGB) sensor), a living body sensor 1240I, a temperature/humidity sensor 1240J, an illuminance sensor 1240K, or a UV light sensor 1240M. Although not illustrated, additionally or alternatively, the sensor module 1240 includes, an E-nose sensor, an electromyography sensor (EMG) sensor, an electroencephalogram (EEG) sensor, an electrocardiogram (ECG) sensor, a photoplethysmographic (PPG) sensor, an infrared (IR) sensor, a biometric sensor, an iris sensor, and/or a fingerprint sensor. The sensor module 1240 includes a control circuit for controlling at least one or more sensors included therein. According to an embodiment of the present disclosure, the electronic device 1201 includes a sensor processor which is part of the application processor 1210 or is independent of the application processor 1210 and is configured to control the sensor module 1240. The sensor processor controls the sensor module.

The input device 1250 includes, for example, a touch panel 1252, a (digital) pen sensor 1254, a key 1256, or an ultrasonic input unit 1258. The touch panel 1252 uses at least one of capacitive, resistive, infrared and ultrasonic detecting methods. The touch panel 1252 also includes a control circuit. The touch panel 1252 includes a tactile layer to provide haptic feedback or a tactile reaction to a user input.

The (digital) pen sensor 1254 may be, for example, a part of a touch panel or includes an additional pen sensor panel for input recognition. The key 1256 includes, for example, a physical button, an optical key, a keypad, and the like. The ultrasonic input device 1258 detects (or senses) an ultrasonic signal, which is generated from an input device, through a microphone 1288 and processes data corresponding to the detected ultrasonic signal.

The display 1260 (e.g., a display 1260) includes a panel 1262, a hologram device 1264, or a projector 1266. The panel 1262 may be configured the same as or similar to the display 110 of FIG. 1. The display panel 1262 and the touch input panel 1252 may be integrated into a single module. The hologram device 1264 displays a stereoscopic image in a space using a light interference method. The projector 1266 projects light onto a screen so as to display an image. The screen may be arranged inside or outside of the electronic device 1201. According to an embodiment of the present disclosure, the display 1260 includes a control circuit for controlling the panel 1262, the hologram device 1264, or the projector 1266.

The interface 1270 includes, for example, an HDMI (high-definition multimedia interface) 1272, a USB (universal serial bus) 1274, an optical interface 1276, or a D-sub (D-subminiature) 1278. Additionally or alternatively, the interface 1270 includes, for example, a mobile high definition link (MHL) interface, a secure digital (SD) card/multi-media card (MMC) interface, or an infrared data association (IrDA) standard interface.

The audio module 1280 converts sound into an electric signal bidirectionally and in full duplex mode. The audio module 1280 processes, for example, sound information that is input or output through a speaker 1282, a receiver 1284, an earphone 1286, or a microphone 1288.

The camera module 1291 for shooting a still image or a video image includes, for example, at least one image sensor (e.g., a front sensor or a rear sensor), a lens, an image signal processor (ISP), or a flash (e.g., an LED or a xenon lamp).

The power management module 1295 manages, for example, power consumption and distribution in the electronic device 1201. According to an embodiment of the present disclosure, a power management integrated circuit (PMIC), a charger IC, or a battery gauge may be included in the power management module 1295. The PMIC may have a wired charging method and/or a wireless charging method. The wireless charging method includes, for example, a magnetic resonance method, a magnetic induction method or an electromagnetic method and includes an additional circuit, for example, a coil loop, a resonant circuit, or a rectifier, and the like. The battery gauge measures, for example, the remaining capacity of the battery 1296 and the voltage, current or temperature thereof. The battery 1296 includes, for example, a rechargeable battery or a solar battery.

The indicator 1297 displays a specific state of the electronic device 1201 or a portion thereof (e.g., a processor 1210), such as a booting state, a message state, a charging state, and the like. The motor 1298 converts an electrical signal into a mechanical vibration and generates the following effects: vibration, haptic, and the like. Although not illustrated, a processing device (e.g., a GPU) for supporting a mobile TV may be included in the electronic device 1201. The processing device for supporting a mobile TV processes multimedia data according to the standards of DMB, digital video broadcasting (DVB), MediaFlo™, and the like.

Each of the above-mentioned elements of the electronic device according to embodiments of the present disclosure may be configured with one or more elements, and the names of the elements may be changed according to the type of the electronic device. The electronic device according to embodiments of the present disclosure includes at least one of the above-mentioned elements and some elements may be omitted or other additional elements may be added. Furthermore, some of the elements of the electronic device according to embodiments of the present disclosure may be combined with each other so as to form one entity, so that the functions of the elements may be performed in the same manner as before the combination.

The term “module” used herein may represent, for example, a unit including one or more combinations of hardware, software and firmware. The term “module” may be interchangeably used with the terms “unit”, “logic”, “logical block”, “component” and “circuit”. The “module” may be the minimum unit of an integrated component or may be a part thereof. The “module” may be a minimum unit for performing one or more functions or a part thereof. The “module” may be implemented mechanically or electronically or a combination thereof. For example, the “module” may include at least one of an application-specific IC (ASIC) chip, a field-programmable gate array (FPGA), and a programmable-logic device for performing some operations, which are known or will be developed.

At least a portion of an apparatus (e.g., modules or functions thereof) or a method (e.g., operations) according to various embodiments of the present disclosure may be, for example, implemented by instructions stored in a computer-readable storage media in the form of a program module. The instructions, when executed by one or more processors (e.g., a processor 1210), causes the one or more processors to perform a function corresponding to the instruction. The computer-readable storage media, for example, may be the memory 1230.

A computer-readable recording medium includes a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk), and hardware devices (e.g., a read only memory (ROM), a random access memory (RAM), or a flash memory). A program instruction includes not only executable code such as code generated by a compiler but also a high-level language code executable on a computer using an interpreter. The above hardware unit may be configured to operate via one or more software modules for performing an operation of the present disclosure, and vice versa.

A module or a program module according to various embodiments of the present disclosure includes at least one of the above elements, or a portion of the above elements may be omitted, or additional other elements may be further included. Operations performed by a module, a program module, or other elements according to various embodiments of the present disclosure may be executed sequentially, in parallel, repeatedly, or in a heuristic method. A portion of operations may be executed in different sequences, omitted, or other operations may be added.

According to various embodiments of the present disclosure, electronic device users may minimize inconvenience and increase user satisfaction by displaying content images at convenient viewing angles in electronic devices equipped with various shapes of displays.

According to various embodiments of the present disclosure, a function key or a user interface (UI) may be displayed on an area of the display other than the content display area, thereby more effectively utilizing the display area and providing various types of user interfaces (UIs).

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display configured to display content on a part of a display area;
a sensor module configured to sense locations of both eyes of a user; and
a control module configured to change a content display area of the display based on the locations of both eyes of the user.

2. The electronic device of claim 1, wherein the control module is configured to change at least one of a shape, a size, and an angle of the content display area.

3. The electronic device of claim 2, wherein the control module is configured to change the content display area by rotating the content display area relative to a center point of the display.

4. The electronic device of claim 2, wherein the control module is configured to change an angle of the content display area such that a horizontal line of the content display area is parallel with a perpendicularly projected line of a straight line passing through both eyes of a user on a display surface.

5. The electronic device of claim 2, wherein the control module is configured to change the size of the content display area so as to have a maximum size without changing the shape of the content display area.

6. The electronic device of claim 1, further comprising:
a gravity sensor configured to sense a direction of gravity,
wherein the control module is configured to change the content display area of the display based on the direction of gravity.

7. The electronic device of claim 6, wherein the control module is configured to change the content display area such that a perpendicular line of the content display area is parallel with a perpendicularly projected vector of a vector indicating the direction of gravity on the display surface.

8. The electronic device of claim 1, wherein the control module is configured to display a function key on an area of the display area other than the content display area.

9. The electronic device of claim 8, wherein the function key comprises at least one of a home key, a back key, a volume control key, a screen brightness control key, and a menu key.

10. The electronic device of claim 1, further comprising:
an input button having a first function,
wherein the control module is configured to change the function of the input button based on a changed angle of the content display area.

11. A display method of an electronic device, the method comprising:
displaying content on a part of a display area;
sensing locations of both eyes of a user using a gaze sensor; and
changing a content display area of a display based on the locations of both eyes of the user.

12. The method of claim 11, wherein changing the content display area of the display comprises:
changing at least one of a shape, a size, and an angle of the content display area.

13. The method of claim 12, wherein changing the content display area of the display further comprises:
changing the content display area by rotating the content display area relative to a center point of the display.

14. The method of claim 12, wherein changing the content display area of the display further comprises:
changing the content display area such that a horizontal line of the content display area is parallel with a perpendicularly projected line of a straight line passing through both eyes of a user on a display surface.

15. The method of claim 12, wherein changing the content display area of the display further comprises:
changing the size of the content display area so as to have a maximum size without changing the shape of the content display area.

16. The method of claim 11, further comprising:
sensing a direction of gravity using a gravity sensor, and
changing the content display area of the display based on the direction of gravity.

17. The method of claim 16, wherein changing the content display area of the display based on the direction of gravity comprises:
changing an angle of the content display area such that a perpendicular line in the content display area is parallel with a perpendicularly projected vector of a vector indicating the direction of gravity on the display surface.

18. The method of claim 11, further comprising:
displaying a function key on an area of the display area other than the content display area.

19. The method of claim 11, further comprising:
changing a function of an input button based on a changed angle of the content display area; and
displaying a function key having a previous function of the input button before a change on the display.

20. The method of claim 19, further comprising:
deleting a function key having a first function from the display if a time period elapses after the function key having the first function is displayed.
